(19) United States
(12) Patent Application Publication
(10) Pub. No.: US 2013/0240811 A1
(43) Pub. Date: Sep. 19, 2013

(54) ROPE GRIP APPARATUS

(71) Applicant: Keith Wilson, Northumberland (GB)

(72) Inventor: Keith Wilson, Northumberland (GB)

(21) Appl. No.: 13/697,447

(22) PCT Filed: May 12, 2011
(86) PCT No.: PCT/GB11/50916

§ 371 Date: Apr. 15, 2013

(30) Foreign Application Priority Data
May 12, 2010 (GB) 1007925.9

(51) Int. Cl. B66D 1/74; A62B 1/08

(52) U.S. Cl. CPC B66D 1/7415; A62B 1/08
USPC 254/342; 188/65.1; 254/371; 254/369

(57) ABSTRACT

Rope grip apparatus for raising or lowering a load has a rope-engaging portion with opposing projections. The opposing projections are arranged to grip a rope by compressing the rope between the projections. In use the rope is fed through the apparatus.

### FIELD OF THE INVENTION

The invention relates to a rope grip apparatus; in particular it relates to a rope grip apparatus which can be used to raise or lower a load.

### BACKGROUND TO THE INVENTION

Activities conducted at height whether recreationally or professionally can be arduous and potentially dangerous and therefore numerous safety devices have been developed to arrest a person during a fall.

In cases where a person wearing a safety device falls from a height, the person will be suspended by the safety equipment but due to suspended orientation or injury, the person may be unable to conduct self recovery. Rescue from this situation should be safe and efficient for all personnel involved.

Many recovery systems utilise a combination of single function components (ie rope clamps and pulleys) assembled by competent operators predominantly as multiple component systems, utilised to create mechanical advantage and configured according to the type of rescue to be effected.

Most of these, due to their complexity, are limited in application whilst relying predominantly on manual exertion, normally requiring more than one operator.

Further restrictions with traditional multiple reeve systems is the potential to overload the system components or load (such is a person) due to the inability to gauge the manual energy applied to the system apparatus, lifting an unknown weight or load snagging during operations.

Equipment such as hoists and winches have been employed to take advantage of a power source to raise or lower a load, inherently they are significantly limited in application due to their mass and weight, often necessitating bolting or other secure fixing whilst requiring rope to be threaded through and attached to the apparatus mechanism, or requiring multiple wraps of rope, significantly restricting the range of application.

U.S. Pat. No. 7,513,334 (Browne) describes a portable power driven rope climbing apparatus, which allows an operator to ascend or descend a rope. The apparatus powers a gear reduction mechanism to drive a main pulley wheel, on which a rope is gripped in a “V” shaped groove. The apparatus further includes a braking mechanism to prevent uncontrolled descent.

In such devices similar to that described in U.S. Pat. No. 7,513,334 (Browne), which can ascend or descend a rope, the gripping mechanism must be extremely strong to perform this function and pass the relevant safety tests. Most of the prior art devices therefore require parts which aggressively grip the rope, for example by using teeth or clamps, which can damage the rope.

It would be desirable to provide an improved rope grip apparatus.

### SUMMARY OF THE INVENTION

The invention provides a rope grip apparatus for raising or lowering a load comprising a rope-engaging portion having opposing projections arranged to grip a rope by compressing the rope between the projections.

Advantageously, in use the rope is fed through the apparatus.

Advantageously, the opposing projections are arranged on the rope engaging portion in offset positions such that the opposing projections cause displacement of adjacent portions of the rope in opposing directions.

Preferably, the opposing projections extend substantially in parallel with one another.

The projections may comprise pins.

The projections may be substantially U shaped.

In a preferred embodiment, the rope engaging portion comprises a pulley wheel.

Advantageously, a first part of the rope engaging portion houses the opposing projections and is removable from a second part of the rope engaging portion.

The first and second parts of the rope engaging portion may comprise co-operating faces and the projections may extend substantially perpendicular to the faces.

An aspect of the invention provides a rope grip apparatus with a channel for loading a rope, the channel having an inlet and an outlet, and wherein the channel comprises a cover which in a closed configuration covers the channel between the inlet and the outlet.

The cover may comprise a flexible flap.

The cover may comprise a lock.

One aspect of the invention provides a rope grip apparatus comprising a guard extending substantially around the perimeter of the channel between the inlet and the outlet such that in use rope is loaded into the channel from a front face of the apparatus.

The rope grip apparatus may further comprise a rope deflector for guiding rope towards the outlet.

Advantageously, the rope grip apparatus comprises a ratchet mechanism.

In a preferred embodiment, the ratchet mechanism comprises a self locking friction clutch.

Advantageously, in a locked position the self locking friction clutch locks the rope engaging portion against movement by a force exerted on a tail rope.

Advantageously, in a locked position the self locking friction clutch permits movement of the rope engaging portion in the direction of the tail rope.

The apparatus may include a gear reduction mechanism, which may include a planetary gear transmission.

The apparatus may include a drive mechanism.

In one embodiment, the drive mechanism comprises an integral power source.

In a preferred embodiment, in use rope travels through at least part of the apparatus in a rotary or linear motion.

The apparatus may form part of a combination or system of rope access devices.

The invention also provides a method of lifting and/or lowering a load comprising the steps of:
i) Loading a rope attached to a load in the rope grip apparatus of any of claims 1 to 20,
ii) Driving the apparatus to feed the rope from an inlet to an outlet or vice versa.

The above described drive mechanism provides for the drive head to be driven in both directions, thereby allowing loads to ascend and descend. However, there are circumstances where it is desirable for ascent to be powered, but descent to be free, or controlled by some means other than the rope grip apparatus. For example, where the apparatus is used in rope access, powered ascent may be desirable, but for efficient working and emergency situations, personnel may wish to control descent using traditional abseiling equipment and techniques.

It would also be desirable to provide an apparatus with the capability to lift under load but to allow free descent. It may also be desirable to provide a means of controlling free descent.

According to a third aspect of the invention there is provided a drive mechanism for a rope grip apparatus of the first and/or second aspects of the invention, the drive mechanism comprising a drive shaft drivingly connected to a rope engaging means, the drive mechanism further comprising a directional bearing having an first part and a second part which are adapted to rotate relative to one another when the first part is rotated in a first direction and to resist relative rotation when the first part is rotated in a second opposite direction, wherein the said first part is attached to the drive shaft to rotate therewith, and wherein the second part of the directional bearing is mounted in a bearing housing, and is selectively fast with respect to a fixed part of the drive mechanism or rotatable relative to said fixed part of the drive mechanism, the mechanism further including an adjustment means configured to control the second part of the directional bearing with respect to the fixed part of the drive mechanism.

Advantageously, the drive shaft is drivingly connected to a rope engaging means by a gear transmission, which may include a planetary gear transmission or a spur gear engaging with an internally toothed ring gear for example.

Preferably, the drive mechanism includes a brake assembly, comprising a brake actuator and at least one element of brake material situated between the second part of the directional bearing and the fixed part of the drive mechanism.

Preferably, the fixed part of the drive mechanism is the bearing housing.

The brake actuator may comprise a plate having a flange extending therefrom and adapted to engage with the bearing housing, the brake actuator including means to control the position of the plate with respect to bearing housing. Advantageously, the flange is internally threaded and the bearing housing is externally threaded.

In one embodiment of the drive mechanism, a first element of brake material is situated between an outer face of the second part of the directional bearing and a fixed part of the drive mechanism and second element of brake material is situated between an opposing face of the second part of the directional bearing and a part of the brake actuator. So configured, when an axial force is exerted on the second element of brake material the second part of the directional bearing is subjected to frictional braking forces generated by both the first and second elements of brake material and rotation of the second part of the directional bearing with respect to the bearing housing is resisted.

In another embodiment, the second part of the directional bearing may comprise a part of or be mounted in a part of a taper lock. The bearing housing may comprise a part of or be mounted in a part of a taper lock. One skilled in the art will understand that when the taper lock is locked, the second part of the directional bearing would be locked against rotation and when unlocked free to rotate. A taper lock may be provided with one or more elements of brake material between the adjacent tapered faces of the taper lock and may therefore be used to control the speed of rotation of the second part of the directional bearing with respect to the stationary part of the taper lock.

The reference to a directional bearing in the context of the present invention shall be understood include such bearings where the bearing surfaces are bushes as well as those including elements mounted in the bearing to rotate, such as balls or needles for example.

According to a fourth aspect of the invention there is provided a rope grip apparatus comprising a rope deflector for guiding rope towards the outlet.

As will be clear from the description of the preferred embodiments of the invention, the apparatus described in the four aspects of the invention and their preferred features may form part of a single piece of equipment.

### BRIEF DESCRIPTION OF THE DRAWINGS

FIG. 1 is a perspective view of one embodiment of the rope grip apparatus of the invention;

FIG. 2 is a perspective view of the embodiment of the rope grip apparatus of FIG. 1;

FIG. 3a is a side view of the embodiment of the rope grip apparatus of FIG. 1;

FIG. 3b is a cross sectional view of the embodiment of the rope grip apparatus of FIG. 1;

FIG. 4 is a plan view of the ratchet mechanism of the rope grip apparatus of FIG. 1;

FIG. 5a is a schematic representation of a portion of the rope grip apparatus of FIG. 1;

FIG. 5b is a schematic representation of the pulley wheel of the rope grip apparatus of FIG. 1;

FIG. 5c is a schematic representation of the pulley wheel of the rope grip apparatus of FIG. 1;

FIG. 6a is a schematic representation of one embodiment of the pulley wheel of the rope grip apparatus;

FIG. 6b is a schematic representation of one embodiment of the pulley wheel of the rope grip apparatus;

FIG. 6c is a schematic representation of one embodiment of the pulley wheel of the rope grip apparatus;

FIG. 6d is a schematic representation of one embodiment of the pulley wheel of the rope grip apparatus;

FIG. 6e is a schematic representation of one embodiment of the pulley wheel of the rope grip apparatus;

FIG. 7 is a schematic representation of a portion of the rope grip apparatus of FIG. 1;

FIG. 8 is a schematic representation of a portion of the rope grip apparatus of FIG. 1 showing the clutch mechanism; and

FIG. 9 is a cross-sectional elevation of a rope grip apparatus according to the invention having an alternative drive mechanism.

### DETAILED DESCRIPTION OF THE PREFERRED EMBODIMENTS

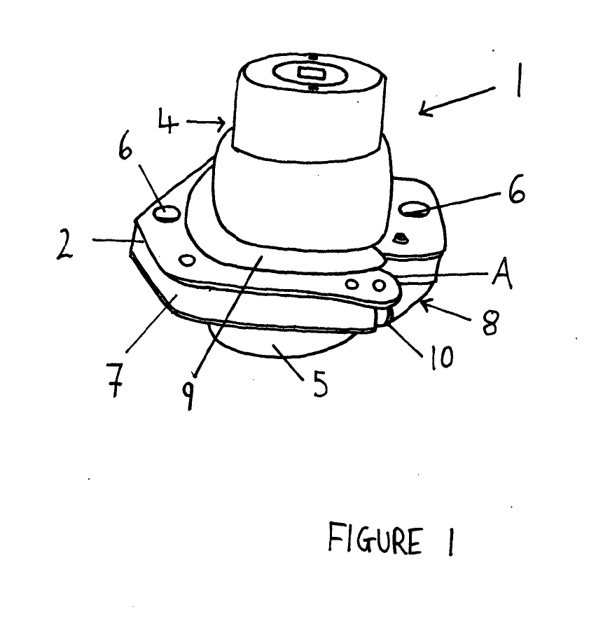

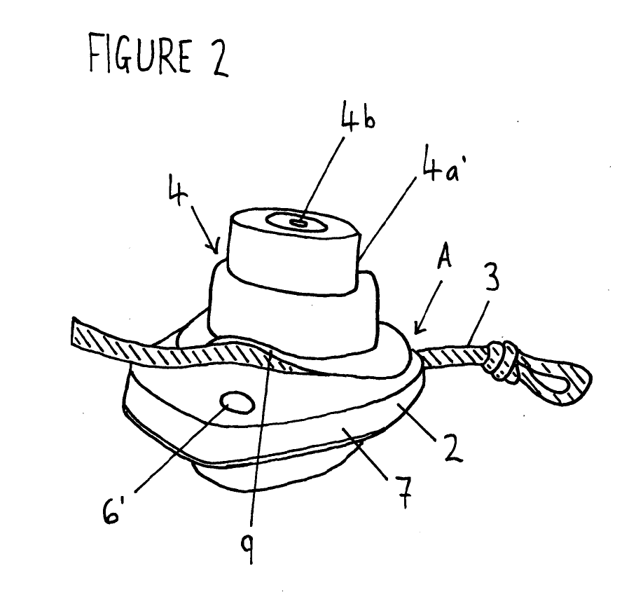

As illustrated in FIGS. 1 and 2, a rope grip apparatus 1 comprises a portion 2, in which a rope 3 is mountable, and a drive assembly 4 connected to a gearbox assembly 5.

The rope grip apparatus 1 engages and grips a rope 3 and enables an operator to control rope movement through the apparatus.

In the embodiment shown in FIGS. 1 and 2, the portion 2 of the apparatus 1 is located between the drive assembly 4 at the front side of the apparatus and the gearbox assembly 5 at the rear side of the apparatus. The portion 2 extends beyond the perimeter of the gear box assembly 5 and drive assembly 4 and includes holes 6, into which further fixings such as karabiners or ropes may be secured.

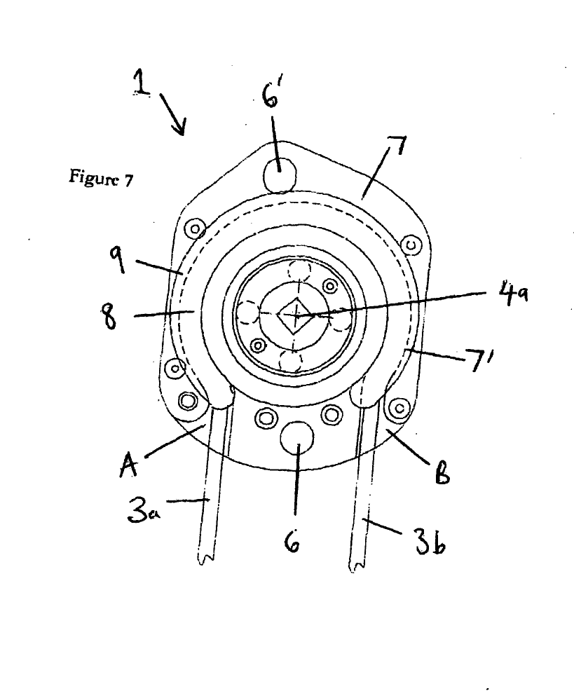

The anchor holes 6 are positioned such that the apparatus hangs in the optimum orientation when suspended from an anchor hole 6. In the orientation shown in FIG. 7, hole 6′ is the top anchor hole and the lower hole 6 is available to accept a karabiner or other rope devices such that the apparatus 1 may be used in combination with one or more rope access devices. For example, a rope may be threaded through a separate descending device and anchored to the lower hole 6, in which configuration the apparatus 1 may be used for lifting only and the descending device used for lowering. Alternatively, a rope could be attached to the lower hole 6 and fed into the apparatus 1 to create a loop from which a pulley could be attached to increase mechanical advantage.

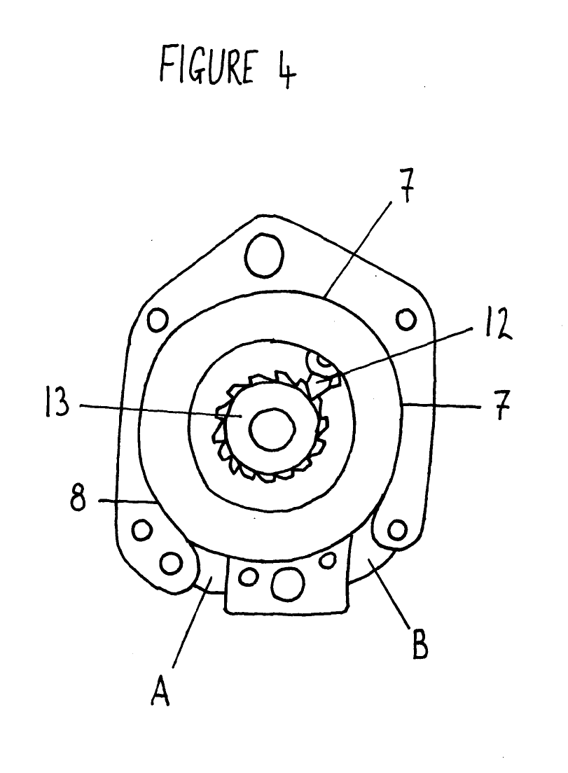

The portion 2 includes a side guard 7 mounted between plates 2′. The side guard 7 is preferably formed of polyacetal material having a substantially cylindrical inner profile 7′. The inner profile 7′ of the side guard 7 is shaped to form a channel 8 in the portion 2, which can be seen in more detail in FIGS. 4, 5a and 7.

Rope 3 is fed into the apparatus 1 at the entrance to the channel 8 (labelled A) and looped around the channel 8 as shown in FIG. 2 by lifting flexible flap 9 and pushing the rope 3 past the flap 9, which flexes to allow easy insertion of the rope 3 into the channel 8. Once loaded into the channel 8, the rope is pulled down between projections 14, 14′ on a pulley wheel 20 in the channel 8.

This arrangement provides a front loading apparatus 1, into which a rope 3 can be easily loaded using method requiring only one hand. In contrast, most prior art devices include a pulley that extends beyond the device housing and onto which a rope is loaded from above.

A roller 10 located at the entrance A assists in guiding the rope 3 into the channel 8 during use and minimises frictional forces between the rope 3 and the apparatus 1.

Alternatively, the rope 3 may be fed into the apparatus 1 in the opposite direction (ie from the exit B to the entrance A) if required.

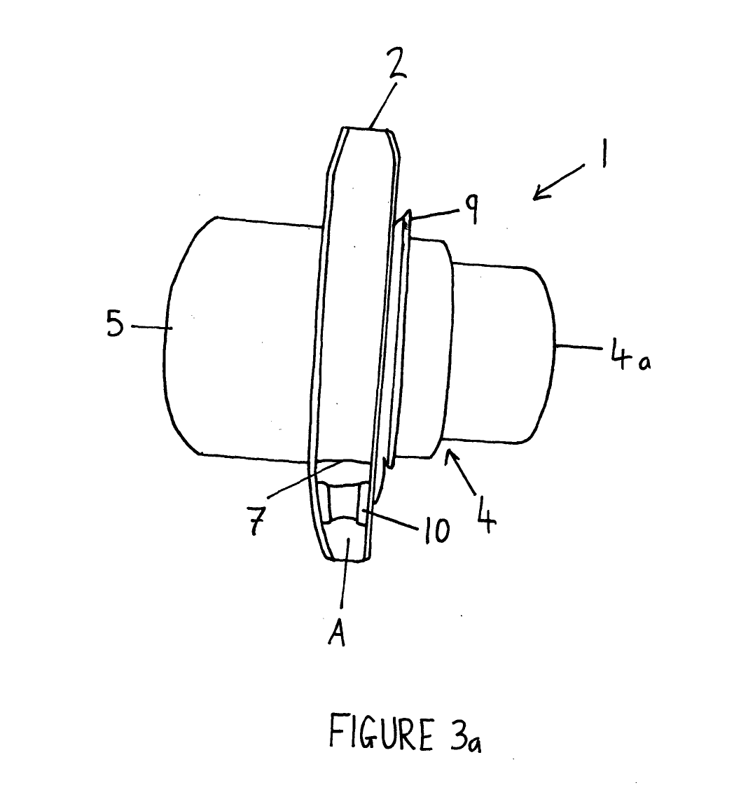

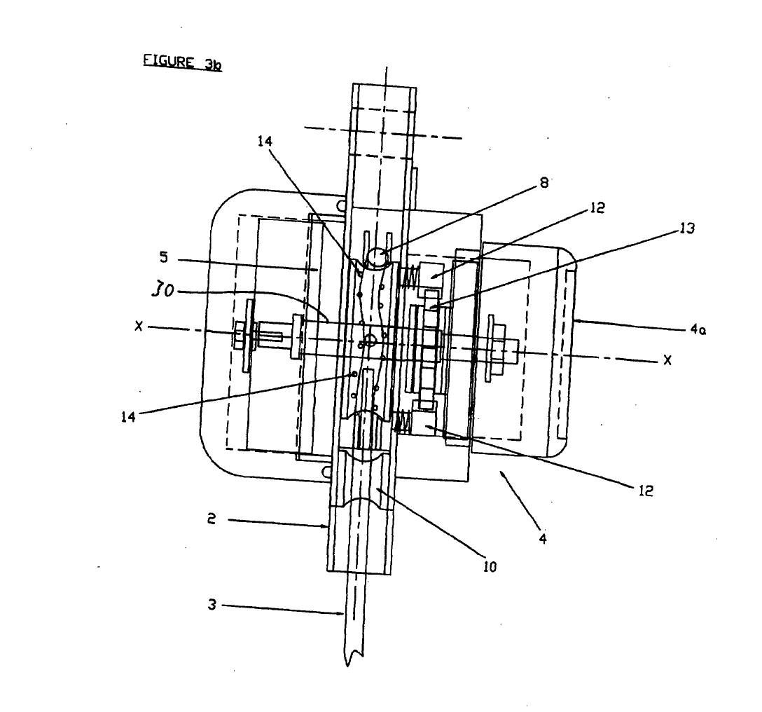

Referring to FIGS. 3a and 3b, the drive assembly 4 comprises a drive head 4a, which in the present example comprises a rotatable hand grip 4a′ having a knurled surface for example, which may be manually driven by turning in a clockwise or anticlockwise direction, by either gripping the handgrip 4a′ or by engaging a manually operated driver that engages the square drive 4b. Similarly, the drive head 4a may be driven by an external energy source such as an electric (mains/battery), compressed air or hydraulic driver provided with a bit to engage the square drive 4b. The drive head 4a may be interchangeable to accommodate different or additional external drive components.

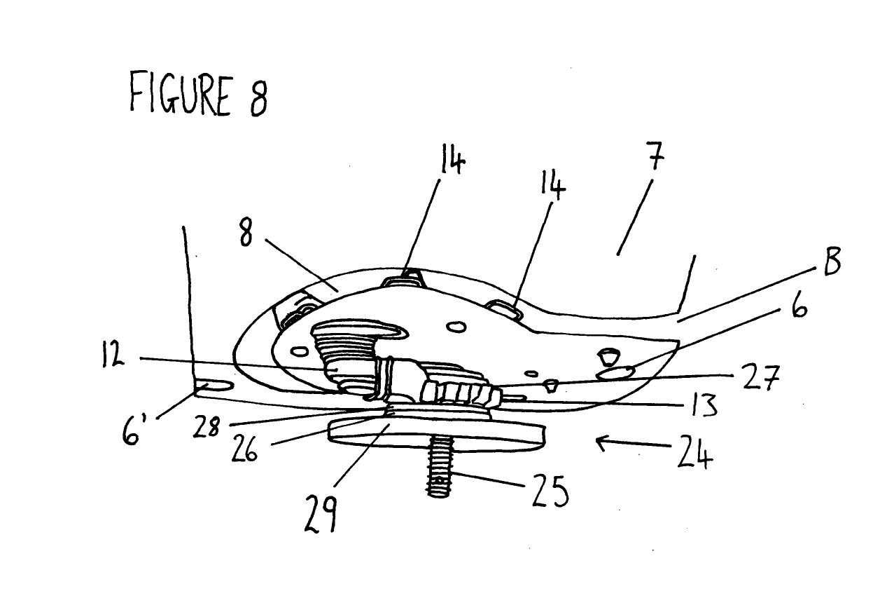

The drive assembly transmits rotational power to the gearbox assembly 5 by means of a drive shaft 30, via a clutch (as described in detail with reference to FIGS. 3b and 8 below). The gearbox assembly 5 of the present embodiment is a planetary gear system where the sun is powered by the drive shaft 30, the out ring is held stationary in the gearbox housing and rotational power is transmitted to the pulley 20 by the planet carrier which engages with an adjacent face of the pulley 20.

In one embodiment the apparatus 1 includes an integral driver and power source.

The drive assembly 4 houses a ratchet mechanism, which includes a biased pawl 12 arranged to engage gear 13. The ratchet mechanism is connected to a drive shaft 11 and allows rotation of the drive shaft 11 in a clockwise direction as indicated by the arrow in FIG. 4. The drive shaft 11 is shown in FIG. 3b and extends through the apparatus 1 from the front to the rear, such that the apparatus is secured together along the drive shaft and remains so even if other screws or bolts are removed. In one embodiment, the apparatus 1 could be arranged in a swing cheek type configuration in which parts are rotatable about the central drive shaft 11.

In a preferred embodiment the ratchet mechanism comprises two double sprung pawls 12 mounted in the drive assembly 4 at 180° to each other as shown in FIG. 3b. A single pawl 12 is shown engaging the gear 13 in the cross sectional view through the apparatus shown in FIG. 4. Whether a single pawl 12 or double pawls 12 are provided, the individual pawls may be single or double sprung. The advantage of double springing is that if one spring fails there is a second spring to force the pawl into engagement with the ratchet. The provision of two pawls 12 180° apart provides for further safety in the event of pawl spring failure, since one of the pawls 12 is likely to be urged against a ratchet tooth simply by gravity.

The pulley wheel 20 is mounted on an outer sleeve of the drive shaft 11 in the portion 2. Rotation of the inner shaft and gearbox mechanism causes the outer sleeve and hence the pulley wheel 20 to be turned.

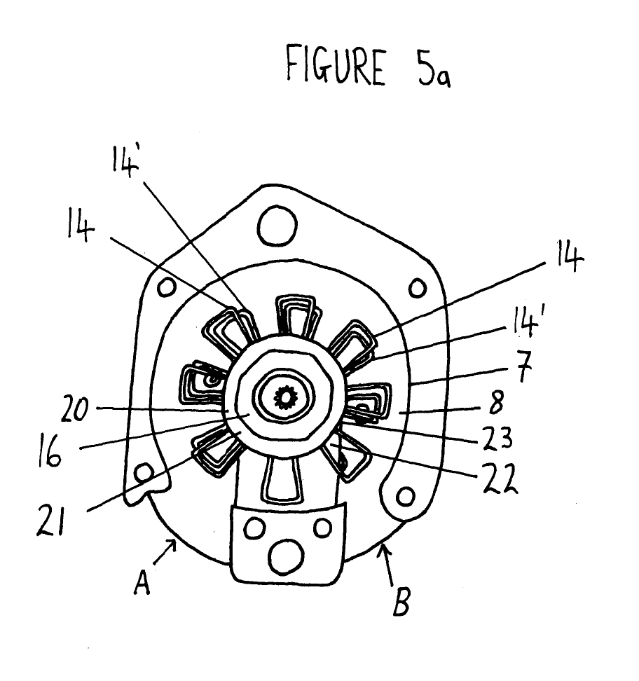

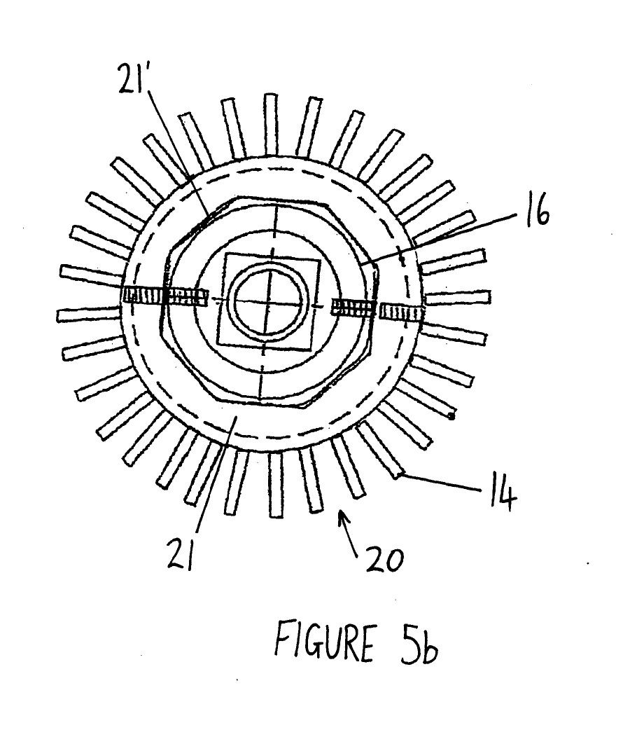

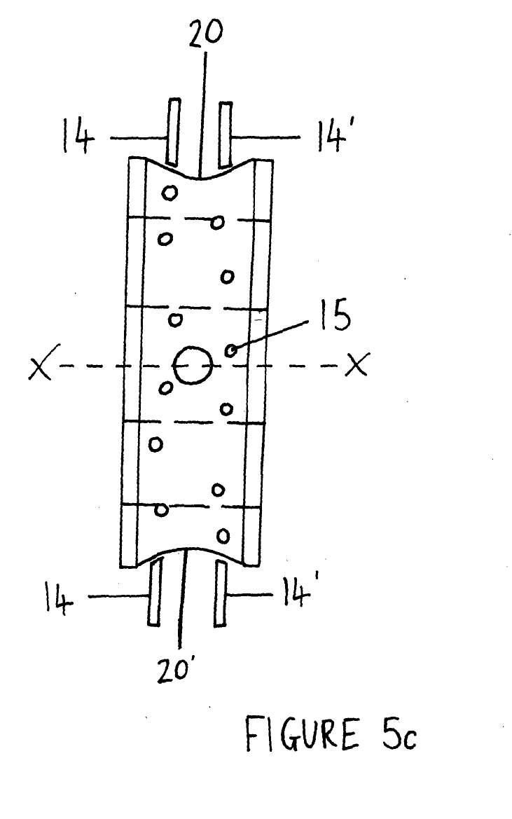

As illustrated in FIGS. 5a, 5b and 5c, the pulley wheel 20 has a concave circumferential profile 20′. Projections 14 extend radially from apertures 15 in the circumferential profile 20′. Distance and degree of offset between projections 14 are calculated according to rope specifications, type and diameter. In a preferred embodiment the distance between opposing projections in each pair is the same and the distance between adjacent projections on sides of the pulley wheel 20 is the same. It can be seen from FIG. 3b that in addition to the apertures 15 and hence projections 14 being offset with respect to the centre line of the pulley wheel 20, the apertures 15 to one side of the centre line are staggered with respect to the apertures to the other side of the centre line.

The pulley wheel 20 and projections 14 may be formed from stainless steel or form cast.

The apertures 15 and hence projections 14 are positioned on the pulley wheel 20 in staggered offset positions as illustrated in FIGS. 5a and 5c. In this arrangement, a rope 3 is gripped between the projections in such a way to cause the rope 3 to assume a tortuous configuration on the pulley wheel 20, forming a “lazy S” shape (as shown in FIG. 3b).

The rope 3 is compressed between the projections 14, which causes the circumferential profile of the rope to change.

The position of the pins may be varied depending on the width of rope or level of grip required. A greater the offset, between projections 14 causes a larger the “S” shape to form in the rope and the rope is gripped more tightly. In a preferred embodiment, the optimum distance between opposing projections 14, 14′ is around two thirds of the width of the rope to be gripped.

As shown in FIGS. 5a and 5c, the projections 14, 14′ extending from opposite sides of the pulley wheel 20 are parallel.

The projections 14, 14′ extend at substantially 90 degrees from the axis X-X′ of the pulley wheel 20.

When a rope is pushed between the projections 14, 14′, the projections may be deflected outwards slightly by the force of the rope. The angle of deflection is between 1 and 4.5 degrees.

The angle of deflection of the projections 14 is limited by the side plates (not shown) on each side of the pulley wheel 13. The side plates may contain grooves cut to accommodate the outer edges of the projections 14 and restrict deflection of the projections 14.

The pulley wheel 20 has an octagonal inner plate 16 having eight flat faces 16′. An outer plate 21 with an octagonal opening having corresponding flat faces 21′ fits on to the inner plate 16.

The projections 14 are secured in holes (not shown) in the outer plate 21 and extend through the concave profile 20′ of the pulley wheel 20. The projections 14 extend from the inner faces 21′ of the outer plate at around 90 degrees to the faces 21′. The outer plate 21 is a single piece, but in an alternative embodiment it may be made of segments joined together.

The outer plate 21 is interchangeable and removable from the inner plate 16 such that it may be replaced with another outer plate, for example an outer plate carrying projections of a different size or arrangement.

In a preferred embodiment, the projections 14 are generally “U” shaped pins as shown in FIG. 5a, although a number of alternative embodiments are envisaged.

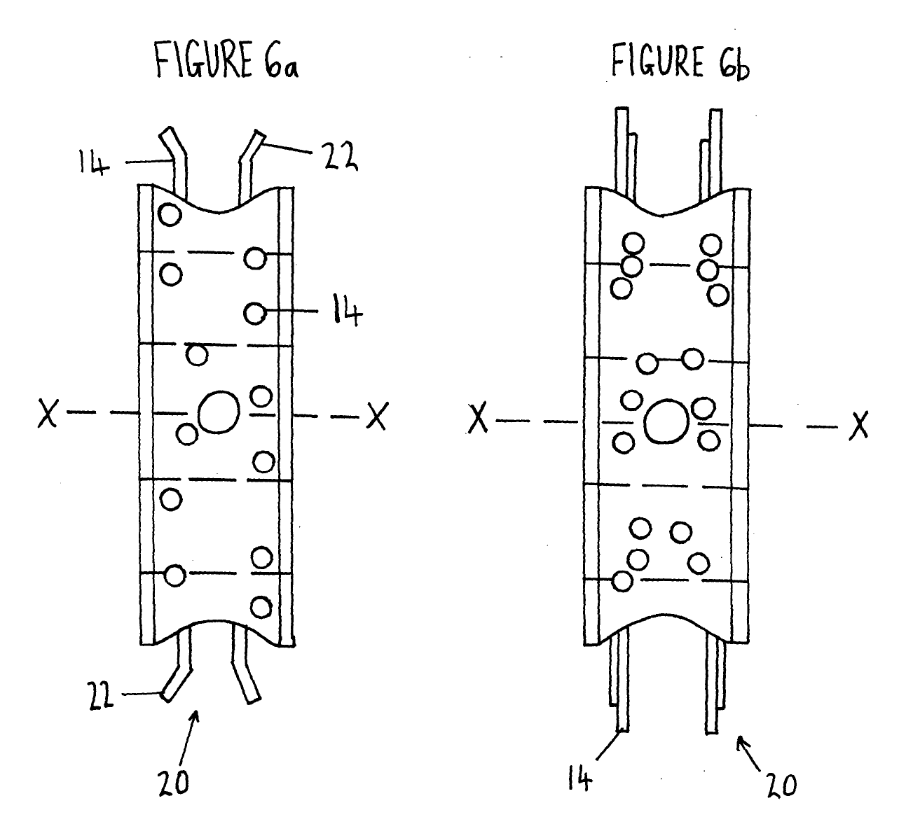

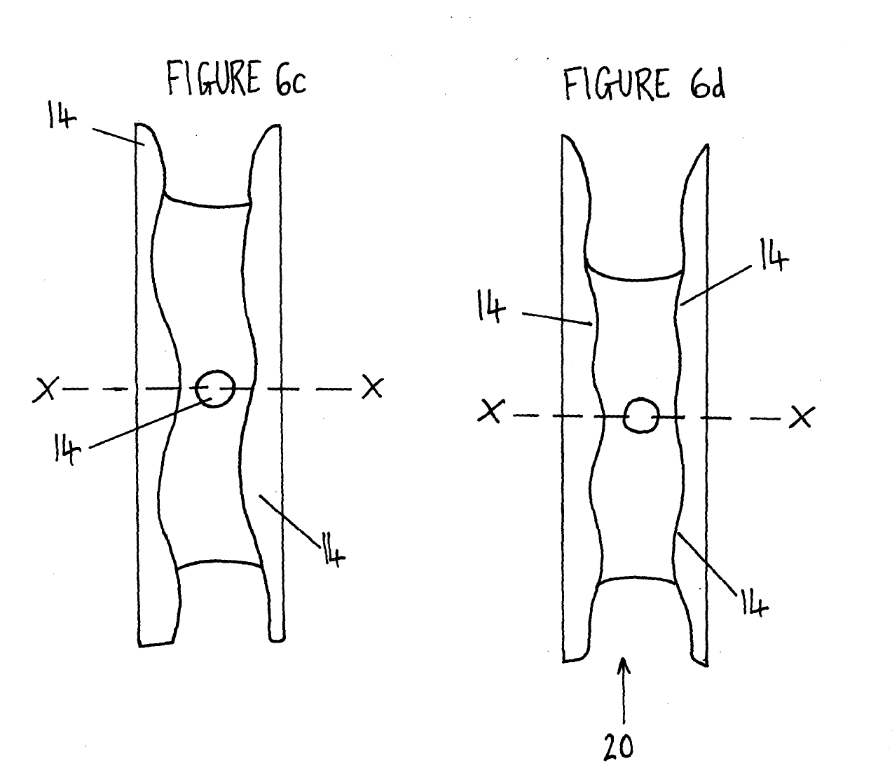

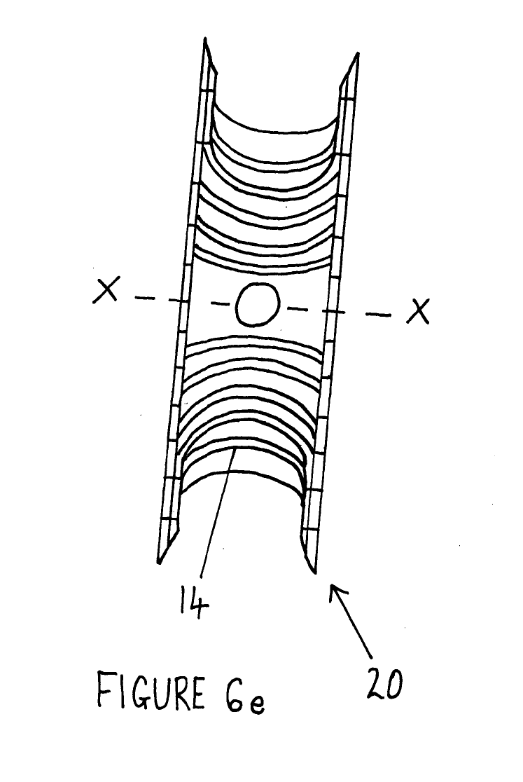

Alternative embodiments of the arrangement of the pulley wheel 20 and projections 14 are shown in FIGS. 6a to 6e. In one embodiment, the projections may have profiled outer edges 22 to facilitate pick up of the rope 3 from entrance A as shown in FIG. 6a.

FIGS. 6a to 6e show alternative embodiments of grip mechanisms of the apparatus 1. FIG. 6b shows an alternative arrangement of projections 14 on the pulley 20. FIGS. 6c and 6d show projections 14 which form a continuous gripping surface and may be formed integrally with part of the pulley 20. FIG. 6e shows another embodiment having “C” shaped gripping projections 14.

Rope 3 is fed into the apparatus 1 at entrance A and looped around the pulley wheel 14 in the channel 8 by pushing the rope past the flexible channel cover 9. The rope is looped in the channel 8 from entrance A to exit B and pulled downwards to pull the rope between the projections 14 and 14′ on the pulley wheel 13.

Once the rope 3 is gripped between the projections 14, 14′, movement of the rope within the apparatus 1 can be controlled by the drive assembly 2.

The drive head 4a transmits rotational force to gears (not shown) in the gear box assembly 5. In a preferred embodiment the gear box assembly 5 houses a planetary gear arrangement providing an output rotation greater than the input rotation.

Rotation of gears in the gear box assembly drives the pulley wheel 13, causing it to turn in a clockwise direction and take up rope 3 from entrance A.

As the pulley wheel 20 rotates in a clockwise direction, load rope 3a is drawn into the apparatus at entrance A and tail rope 3b moves out of the apparatus at exit B.

A rope deflector 22 located at the exit B assists in removing the tail rope from the pulley wheel 13. The rope deflector 22 is shaped such that rope 3 is fed out of the apparatus 1 without the need for a user to guide it. The tip 23 of the deflector 22 is positioned such that it extends up to the concave surface profile 20′ of the pulley wheel 20. Rope in the pulley wheel 20 is deflected away from the pulley wheel on exiting the apparatus 1 at the exit B.

As illustrated in FIG. 7, the load rope 3a is attached to a load (not shown), which in a rescue situation may be a person. Clockwise rotation of the drive head 4a draws the load rope 3a up into the apparatus, thus pulling the load up.

The apparatus 1 may also be used in an inverted position in which the opening 6′ is attached to a load below the apparatus. In this inverted position, as the drive head 4a is rotated, the apparatus 1, climbs up the rope 3a, pulling the load upwards with it. The apparatus 1 can therefore also be used to ascend a rope as well as to raise and lower a load. It is also compact enough and light enough to be worn by a user.

The ratchet mechanism prevents accidental anticlockwise rotation of the pulley wheel 20 and thus provides a safety lock against descent of the load. However, intentional anticlockwise rotation of the pulley wheel is permitted. In the event of a spring failure on the ratchet, the apparatus 1 is locked by the clutch and ratchet mechanism in a fail safe position.

Rotation of the drive head in an anticlockwise direction by a user allows a user to turn the pulley wheel 20 in an anticlockwise direction and lowers the load.

This is achieved by using a self locking friction clutch of the type used in the chain hoist sold under the name “Elephant Chain Block” and is adapted such that it can be used with the drive head 4a and the bearing on which the circular head runs is mounted inside the housing of the drive assembly 4.

As shown in FIGS. 3b and 8, shaft 30 is driven via a clutch mechanism 24 which includes clutch head 29 mounted on a deep pitch thread 25. Friction plates 26 and 27 are mounted either side of the gear 13, which itself is mounted on the shaft 30 to rotate thereabout. Prior to turning the drive shaft 29 clockwise, a narrow gap exists (not shown) at point 28 between the front friction plate and the gear 13.

As the drive head 4a is turned clockwise, the clutch head 29 turns clockwise and moves along the deep pitch thread 29, urging the front friction plate 26 towards the gear 13, which closes the gap at point 28 and causes the front friction plate 26 to grip the gear 13. The gear 13 must then rotate with the clutch head 29. Further rotation in the clockwise direction causes the pawl(s) 12 to ride over the teeth of the gear 13. In this state, a force acting through the rope to turn the shaft 30 anti-clockwise thereof is resisted by the pawl(s) engaging the teeth of the gear 13, which is locked with respect to the shaft 30.

A load on the rope 3a transmits a turning force directly on the pulley wheel 20 but the clutch assembly 24 locks against the ratchet and prevents it from turning anticlockwise against the sprung pawls.

However, the pulley wheel 20 maybe turned anti-clockwise via the drive head 4a. Turning the drive head 4a anticlockwise turns the clutch head 29 anti-clockwise and causes movement thereof along the thread 25, restoring the gap at point 28 between the front friction plate 26 and the gear 13. When a gap exists between the front friction plate 26 and the gear 13, the pawls 12 remain engaged with the gear 13 but the clutch head is not pressing against the friction plate 26, which in turn is not pressing against gear 13. The shaft 30 which is driven directly by the clutch head 29 rotates anti-clockwise and relative to the gear 13 which is held in position by the pawl(s) 12.

The apparatus 1 may be used in the orientation shown in FIG. 7, or may be used in another orientation, such as an inverted orientation in which rotation of the pulley wheel 20 causes the apparatus 1 itself to ascend or descend a rope 3.

The apparatus 1 accommodates EN 1891 type B low stretch rope, but other types of rope can be used and the apparatus 1 may be modified to accommodate different sizes of rope.

The apparatus has the advantage that no aggressive grip components are utilised to grip the rope, which minimises rope chaffing and damage. In a preferred embodiment, the apparatus has an approximate weight of 2.2 kg and the height is around 160 mm. The width from the front to rear is around 22 mm. Preferably the length of the apparatus 1 from the drive head 4a to the outer face of the gearbox assembly 5 is around 120 mm.

In an alternative embodiment, the apparatus 1 may include more than one pulley wheel 20. In particular, a second pulley wheel may be mounted on the front of the apparatus 1.

In another alternative embodiment the pulley 20 may be in the form of projections on segments bolted to a chain to form a long gripping chain. Such alternative embodiments can perform linear lifting motion as well as rotary lifting motion. The pulley in this embodiment may therefore not be a wheel type pulley but a row of segmented rope engaging portions along an elongate chain.

In an alternative embodiment, the projections 14 may be in the form of spikes that aggressively engage a rope.

The apparatus may include a rope lock device in the form of a moveable single hinged cam lever, utilised to lock the rope against the pulley wheel positioned adjacent to rope deflector exit point B FIG. 4.

The apparatus may include a lock device, in the form of a moveable single hinged lever, attached and hinged from the front face of item 2 bridging channel 8 terminating in groove formed to outer face of ratchet cover FIG. 3b

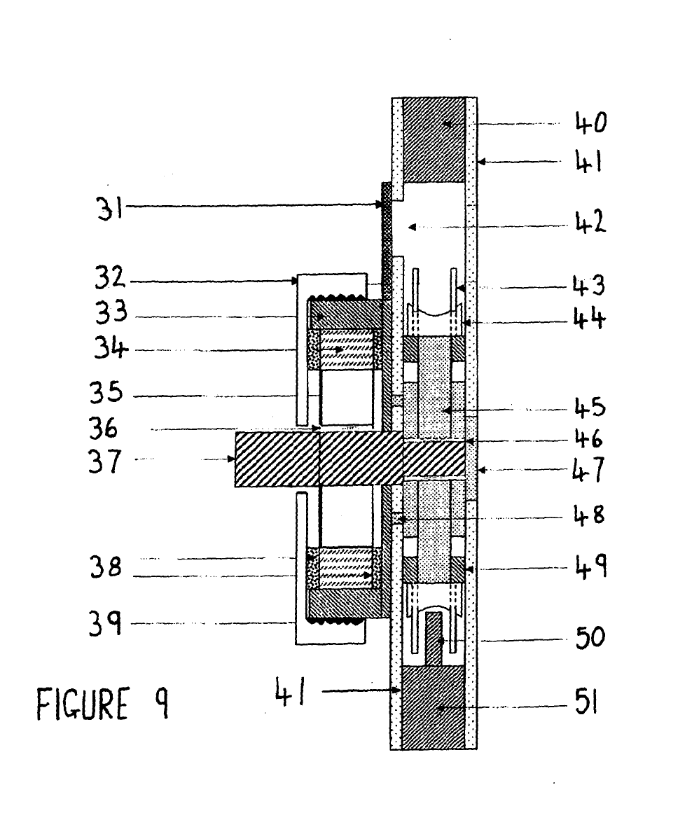

Referring now to FIG. 9, an alternative drive mechanism is illustrated which provided for powered movement of the pulley in one direction and allows the pulley to free wheel, or to free wheel in a controlled manner in the other direction.

The apparatus illustrated in FIG. 9 comprises a pulley wheel 44 mounting a plurality of pins 43. The pulley 44 is mounted on a drive shaft 37 via a gearbox assembly 45, which in the illustrated embodiment is a planetary gearbox, where the drive shaft 37 is attached to the sun thereof. The planet carrier is fixed by pins 48 which extend into corresponding apertures in the plate 41, and hence in this embodiment the sun rotates, the planets rotate about their individual axes, but are fixed with respect to the sun, and the outer ring is driven to rotate by the planet gears. The pulley 44 is carried on the outer ring of the planetary gear box.

The drive shaft 37 extends through a bearing or bush which permits rotation in one direction, but prevents rotation in the opposite direction. One such bearing or bush which provides this function is known as a sprag bearing or a sprag bush. The sprag bearing or bush comprises an inner part 35 and an outer part 34.

The inner part 35 is attached to the drive shaft 37 by means of a key 36. The key 36 and corresponding key way in the inner part 35 of the sprag bearing fix the inner part 35 such that it must rotate with the drive shaft 37.

The outer part 34 of the sprag bearing is mounted in a bearing carrier 33 which is attached to one of the plates 41 of the apparatus. The outer part 34 of the sprag bearing may be selectively fixed against rotation with respect to the bearing carrier 33, or free to rotate with respect to the outer carrier 33. A brake assembly comprises a first brake pad 38 mounted between the opposing faces of the inner part 35 of the sprag bearing and the plate 41, and a second brake pad 38 mounted between the opposing faces of the inner part 35 of the sprag bearing and a brake adjustment member 32. The brake adjustment member 32 includes a flange 32′ that extends over the bearing carrier 33. The flange 32′ is threaded internally and the surface of the bearing carrier 33 that is overlies is correspondingly threaded such that when the brake adjustment member 32 is turned in one direction it moves towards the plate 41 and engages with the adjacent brake pad 38 and forces the outer part 34 of the sprag bearing and the opposing face of the plate 41 to engage with the brake pad 38 situated therebetween. The greater the extent of rotation of the brake adjustment member in the aforementioned direction, the greater the braking force. Hence, with the brake adjustment member 32 adjusted so that the outer part 34 of the sprag bearing is fast with respect to the plate 41, the pulley 44 may only rotate in one direction.

In the above paragraph the outer part 34 of the sprag bearing may include a casing or spacer element that is attached thereto, and it may be that the brake pads 38 engage with this casing or spacer element.

The drive mechanism illustrated in FIG. 9 permits either free or controlled rotation of the pulley 44 in the opposite direction. When the brake adjustment member 32 is rotated such that it moves away from the plate 41, the axial force generated by the brake adjustment member 32 is reduced and hence the frictional forces generated between the brake pads 38 and the surfaces which they are adjacent to and engage with are reduced. The brake adjustment member 32 may be rotated such that the force exerted on a rope passing over the pulley 44 is just sufficient to overcome the said frictional forces. By further rotating the brake adjustment member 32 the frictional forces are further reduced and the pulley 44 may rotate faster. When the brake adjustment member is rotated such that no or only negligible axial force is exerted on the brake pads 38 the pulley can rotate freely, resisted only by the small frictional forces generated within the gearbox assembly 45.

Depending on the configuration of the selected sprag bearing the drive shaft may rotate in one of the clockwise or anti-clockwise directions. Taking the example of the sprag bearing being configured to permit rotation in the clockwise direction, if a force is exerted on the drive shaft, either by means of a load on the rope, or a load from a drive mechanism, the inner and outer parts 35, 34 of the sprag bearing will interfere and rotation of the drive shaft 37 will be prevented.

1. A rope grip apparatus comprising a channel for loading a rope, the channel having an inlet and an outlet, wherein the channel comprises a cover which in a closed configuration substantially covers the channel between the inlet and the outlet.

2. Rope grip apparatus as claimed in claim 1, wherein the cover comprises a flexible flap.

3. Rope grip apparatus as claimed in claim 1, wherein the cover comprises a lock.

4. Rope grip apparatus as claimed in claim 1, further comprising a guard extending substantially around the perimeter of the channel between the inlet and the outlet such that in use rope is loaded into the channel from a front face of the apparatus.

5. Rope grip apparatus for raising or lowering a load comprising a rope-engaging portion including a pulley mounting opposing sets of projections arranged to grip a rope by compressing it between the projections and wherein in use the rope is fed through the apparatus.

6. Rope grip apparatus as claimed in claim 5, wherein the opposing sets projections are arranged on the pulley in offset positions with respect to the centre line of the pulley such that the opposing projections of the sets cause displacement of adjacent portions of the rope in opposing directions.

7. Rope grip apparatus according to claim 5, wherein the opposing sets of projections are radially offset with respect to one another.

8. Rope grip apparatus as claimed in claim 5, wherein the projections of opposing sets of projections extend substantially in parallel with one another.

9. Rope grip apparatus as claimed in claim 5, wherein the opposing projections comprise pins.

10. Rope grip apparatus as claimed in claim 9, wherein the opposing projections are substantially U shaped.

11. Rope grip apparatus as claimed in claim 5, wherein the pulley comprises a pulley wheel.

12. Rope grip apparatus as claimed in claim 5, wherein the pulley is mounted in a housing and is removable therefrom.

13. Rope grip apparatus as claimed in claim 12, wherein the pulley and the housing comprise co-operating faces and the projections extend substantially perpendicular to the faces.

14. Rope grip apparatus as claimed in claim 5, further comprising a rope deflector for guiding rope towards the outlet.

15. Rope grip apparatus as claimed in claim 5, further comprising a ratchet mechanism.

16. Rope grip apparatus as claimed in claim 15, wherein the ratchet mechanism comprises a self locking friction clutch.

17. Rope grip apparatus as claimed in claim 16, wherein in a locked position the self locking friction clutch locks the rope engaging portion against movement by a force exerted on a tail rope.

18. Rope grip apparatus as claimed in claim 16, wherein in a locked position the self locking friction clutch permits movement of the rope engaging portion in the direction of the tail rope.

19. Rope grip apparatus as claimed in claim 5, further comprising a gear reduction mechanism.

20. Rope grip apparatus as claimed in claim 5, further comprising a drive mechanism.

21. Rope grip apparatus as claimed in claim 20, wherein the drive mechanism comprises an integral power source.

22. Rope grip apparatus as claimed in claim 5, wherein in use rope travels through at least part of the apparatus in a rotary or linear motion.

23. A drive mechanism for a rope grip apparatus, the drive mechanism comprising a drive shaft drivingly connected to a rope engaging means, the drive mechanism further comprising a directional bearing having an first part and a second part which are adapted to rotate relative to one another when the first part is rotated in a first direction and to resist relative rotation when the first part is rotated in a second opposite direction, wherein the said first part is attached to the drive shaft to rotate therewith, and wherein the second part of the directional bearing is mounted in a bearing housing, and is selectively fast with respect to a fixed part of the drive mechanism or rotatable relative to said fixed part of the drive mechanism, the mechanism further including an adjustment means configured to control the second part of the directional bearing with respect to the fixed part of the drive mechanism.

24. A drive mechanism according to claim 23, wherein the drive shaft is drivingly connected to a rope engaging means by a gear transmission; and wherein the gear transmission is one of a planetary gear transmission and a transmission including a spur gear engaging with an internally toothed ring gear.

25. (canceled)

26. A drive mechanism according to claim 23, including a brake assembly, comprising a brake actuator and at least one element of brake material situated between the second part of the directional bearing and the fixed part of the drive mechanism.

27. A drive mechanism according to claim 23, wherein the fixed part of the drive mechanism is the bearing housing.

28. A drive mechanism according to claim 23, wherein the brake actuator comprises a plate having a flange extending therefrom and adapted to engage with the bearing housing, the brake actuator including means to control the position of the plate with respect to bearing housing.

29. A drive mechanism according to claim 28, wherein a first element of brake material is situated between an outer face of the second part of the directional bearing and a fixed part of the drive mechanism and second element of brake material is situated between an opposing face of the second part of the directional bearing and a part of the brake actuator.

30. (canceled)

31. (canceled)

32. (canceled)

33. (canceled)
